(19) United States
(12) Patent Application Publication
(10) Pub. No.: US 2008/0252971 A1
(43) Pub. Date: Oct. 16, 2008

(54) Three-Dimensional/Two-Dimensional Convertible Display Device

(75) Inventors: Byoungho Lee, Seoul (KR); Jae-Hyeung Park, Seoul (KR); Yunhee Kim, Seoul (KR); Joohwan Kim, Seoul (KR)

Correspondence Address: LEXYOUME IP GROUP, LLC, 1233 TWENTIETH STREET, N.W., SUITE 701, WASHINGTON, DC, 20036, US

(73) Assignee: Seoul National University Industry Foundation, Seoul (KR)

(21) Appl. No.: 11/817,429

(22) PCT Filed: Mar. 2, 2005
(86) PCT No.: PCT/KR2005/000575

§ 371 Date: Aug. 30, 2007

(51) Int. Cl. G02B 27/22

(52) U.S. Cl. 359/463

(57) ABSTRACT

A display device convertible between two-dimensional (2D) and three-dimensional (3D) is provided. The convertible display device is based on integral imaging (II) or integral photography (IP) and displays 2D or 3D images. An image processor generates and transmits elemental images to reconstruct a 3D image or transmits a desired two-dimensional image, and a transmission-type display device displays the image received from the image processor. At this time, a diffusion rate (or haze rate) of light illuminated from a point light source array that is made of a plurality of point light sources is controlled by a variable diffuser and as the light illuminates the transmission-type display device, the device displays 2D or 3D images. According to the present invention, a point light source array is generated by controlling a variable diffuser and as a result a display device convertible between 3D and 2D is achieved. Moreover, a 3D image can be made by spatially modulating the light illuminated from a point light source array and, thereby, an available depth region is dramatically improved.

### BACKGROUND OF THE INVENTION

(a) Field of the Invention

The present invention relates to a display system, and in more detail, to a display system that can select a two-dimensional (2D) display mode or a three-dimensional (3D) display mode by using Integral Imaging Technology (Integral Imaging, known as II, or Integral Photography, known as IP).

(b) Description of the Related Art

Lippmann, in 1908, first proposed using a lens array method with II, which is a kind of display system to achieve a 3D display, and this has since been gradually improved upon but this method cannot attract much public attention because of the limitation in the quality of pick up devices and display devices. Recently however, research has become brisk due to advances in camera devices that have high resolving power and display devices that have high resolution.

A conventional 3D display device using II displays a captured image as a 3D image using a lens array, or displays a 3D image based on elemental images formed by computer graphics.

However, the conventional 3D display system has a critical defect in that it can display only 3D images, not 2D images.

### SUMMARY OF THE INVENTION

The present invention has been made in an effort to provide a display device convertible between 2D and 3D.

Also, the present invention has been made in an effort to provide a convertible display device that can enhance the depth of an image based on II.

According to one aspect of the present invention, a convertible display device comprises: an image processing unit that provides elemental images for display of a three-dimensional image or provides a two-dimensional image for display of a two-dimensional image; a transmission-type image display unit that shows the elemental images or the two-dimensional image provided by the image processing unit; an array forming unit that forms a point light source array including a plurality of point light sources, the light from the point light sources being transmitted to the transmission-type image display unit; and a variable diffuser that controls the diffusion rate of the light from the point light source array so that the image displayed by the transmission-type image display unit is displayed as a three-dimensional image or a two-dimensional image.

In displaying a three-dimensional image, the variable diffuser controls the diffusion rate to be lower than a predetermined value, the image processing unit provides the elemental images for the three-dimensional image, and the transmission-type image display unit displays the elemental images.

In displaying a two-dimensional image, the variable diffuser controls the diffusion rate to be higher than the predetermined value, the image processing unit provides and transmits the two-dimensional image as it is to the image display unit, and the transmission-type image display unit displays the two-dimensional image.

### ADVANTAGEOUS EFFECT

The present invention provides a convertible display device that can display a 2D or a 3D image, depending on the mode, on a transmission-type display device by adjusting a diffusion rate of a variable diffuser.

In particular, a 3D mode of the present invention has the conventional advantage of integral imaging, such as supporting continual perpendicular parallax or horizontally parallax within a fixed viewing angle based on the principle of integral imaging method. However, compared to the conventional integral imaging method, it can increase a cubic effect when displaying both a real 3D image and a virtual 3D image without adjusting a distance between a point light source array and a transmission-type display device according to the depth of the 3D image.

Also, a 2D mode of the present invention has an advantage of displaying a 2D image with perfect resolution and field angle by using a transmission-type display device itself, similar to the structure of a general liquid crystal display, by illuminating the transmission-type display panel with diffusion light.

### BRIEF DESCRIPTION OF THE DRAWINGS

FIG. 1 shows the basic concept of conventional Integral Imaging (II).

FIG. 2 shows the basic concept of Computer-Generated integral imaging (CGII).

FIG. 3 shows the concepts of real Integral Imaging and virtual Integral Imaging.

FIG. 4 shows the basic concept of the present invention.

FIG. 5 shows a diagram of the 3D/2D convertible display device according to a first preferred embodiment of the present invention.

FIG. 6 and FIG. 7, respectively show a mechanism of the 3D mode and the 2D mode of the 3D/2D convertible display device according to the first preferred embodiment of the present invention.

FIG. 8 shows how elemental images are generated when the 3D/2D convertible display device displays a 3D image according to the first preferred embodiment of the present invention.

FIG. 9 shows a diagram of the 3D12D convertible display device according to a second preferred embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

First, Integral Imaging (II) will be described in order to understand the 3D/2D convertible display device according to the present invention.

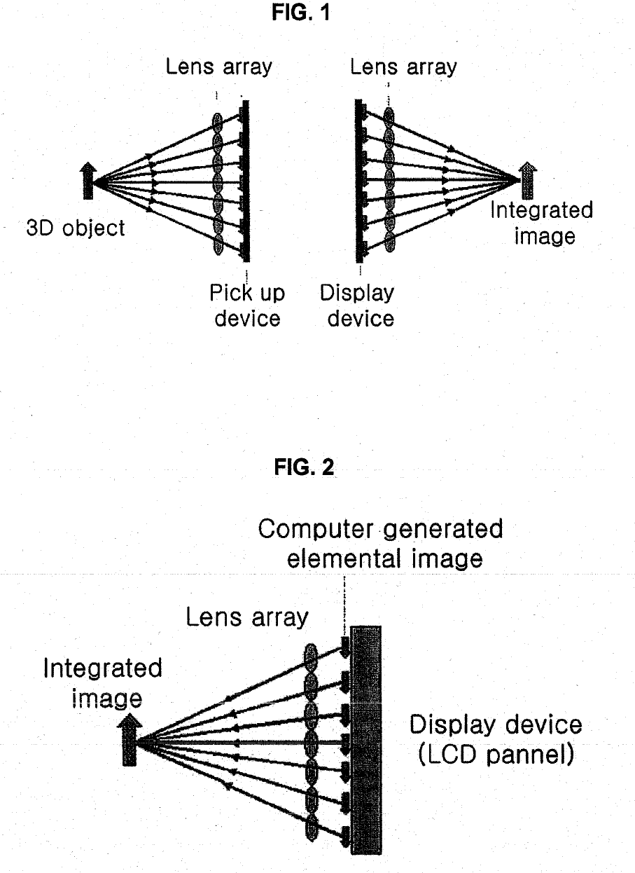

FIG. 1 shows the fundamental concept of conventional II. The system for achieving the II method basically includes two functional parts, a pick up part and a display part, as shown FIG. 1. The pick up part is composed of a lens array that makes an elemental image of a three-dimensional object and a pick up device that saves the elemental image formed by the lens array. The display part is composed of a display device that displays the elemental image picked up by the pick up device and a lens array that forms and displays a three-dimensional image using the elemental image displayed at the display device. Each lens array is composed of a plurality of elemental lenses.

In the pick up part, elemental images for the three-dimensional object are formed by each elemental lens of the lens array and saved by the pick-up device. In the display part, the process of the pick up part is reversed and the saved elemental images are displayed by the display device. The elemental images are integrated and displayed as a three-dimensional image at the position of the original three-dimensional object passing through the lens array. The integrated elemental images by the lens array can be called as an integrated image.

CGII (Computer-Generated Integral Imaging), which generates an elemental image by a computer calculation instead of by the pick up process, is proposed.

FIG. 2 shows the structure of a CGII system. FIG. 2 shows the basic concept of a CGII system. Elemental images, which have information of a virtual three-dimensional object, are generated by a computer and the images is transferred to a display device, for example a liquid crystal display (LCD) panel, that displays the three-dimensional image through a lens array. In this situation, the formed position of the integrated image alters according to the distance between the lens array and the panel of the display device, which can be easily shown by the following equation.

1/d+1/g=1/f [Equation 1]

In the above equation, d is the distance between the integrated image and the lens array, g is the distance between the lens array and the LCD panel, and f is a focal length of the elemental lenses that compose the lens array.

When the distance between the lens array and the LCD panel is longer than the focal length of the elemental lens, the distance value between the formed image and the lens array is a positive number and then the integrated image is formed as a real image in front of the lens array (real image II). On the hand, when the distance between the lens array and the LCD panel is shorter than the focal length of the elemental lens, the distance value between the formed image and the lens array is a negative number and then the integrated image is formed as a virtual image at the back of the lens array (virtual image II).

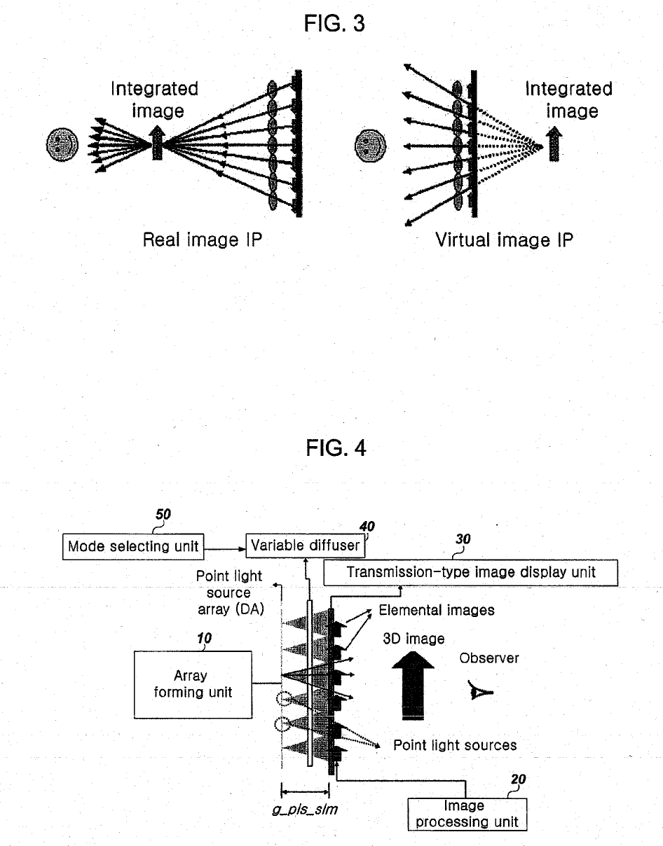

In FIG. 3, the two kinds of display method, i.e., real image II and virtual image II, are shown for comparison. In the case of virtual image II, observers have the benefit of a wider viewing angle since the distance between the integrated image and the observer is longer than in that of real image II. As shown in FIG. 3, the embodiment method of virtual image II is similar to that of real image II except that the elemental image of virtual image II is an erect image unlike the elemental image of the real image II.

In the case of two kinds of II display methods, if the distance between the lens array and the LCD panel is fixed, then the integrated image is formed on a specific plane. Consequently, if the object to be displayed is a 3D object, the resolution of the image is optimized at the central depth plane of the 3D image. Resolution is decreased as the distance between the central depth plane and the image increases because the distance between the lens array and the LCD panel is set based on the central depth plane of the 3D object. The II method therefore has a limit of restricting a displayable thickness of a 3D object. Moreover, for real image II, the distance between the lens array and the LCD panel must be longer than the focal length of the lens array. For virtual image II, the distance between the lens array and the LCD panel must be shorter than the focal length of the lens array. Consequently, in a conventional II method, displaying a real image and a virtual image simultaneously is impossible.

As shown in FIG. 1 and FIG. 2, the observer must look at a 3D image formed and integrated by a lens array because the lens array is in front of the LCD panel in the conventional II method. Undoubtedly, it is possible to display a flat image on any depth plane but, in this case, the resolution and the viewing angle of the displayed image are significantly worse than those of conventional and commercial 2D display systems.

Accordingly, the embodiment of the present invention provides a display device convertible between 2D and 3D. Also, in displaying a 3D image, the convertible display device can enhance the depth of the image based on the II.

FIG. 4 shows the basic concept of the convertible display device according to an embodiment of the present invention.

The embodiment of the present invention uses a point light source array and a transmission-type display device rather than the display device and the lens array of conventional II, and electrically controls the generation of the point light source array using a variable diffuser.

The convertible display device according to the embodiment of the present invention shown in FIG. 4 includes an array forming unit 10 that forms a point light source array having a divergence angle, an image processing unit 20 that provides elemental images for display of a 3D image or provides a 2D image for display of a 2D image, a transmission-type image display unit 30 that shows the elemental images or the 2D image provided by the image processing unit, and a variable diffuser 40 that is placed in front of, or behind, the point light source array and controls the generation of the point light source array. The convertible display device further includes a mode selecting unit 50 that controls a diffusion rate of the variable diffuser 40 according to a mode.

The image processing unit 20 computes and forms elemental images according to information for displaying a 3D image, or provides a 2D image, such as an image captured by an image capturing device, without special processing to the image display unit. That is, the elemental images may be images that the image processing unit 20 generates itself through a special process based on some information. The 2D image may be provided from the outside.

The variable diffuser 40 is a device that electrically controls the diffusion rate of the incident light. The diffusion rate of the variable diffuser may be minimized when a 3D image is displayed, while it may be maximized when a 2D image is displayed.

The mode selecting unit 50 may control the diffusion rate by inputting a voltage to the variable diffuser 40.

Now, a convertible display device according to a first embodiment of the present invention will be described based on the concept above.

The first embodiment of the present invention provides a 3D/2D convertible display device in which a polymer-dispersed liquid crystal is used as an electrically variable diffuser and the array forming unit generates the point light source array by utilizing parallel light and a lens array.

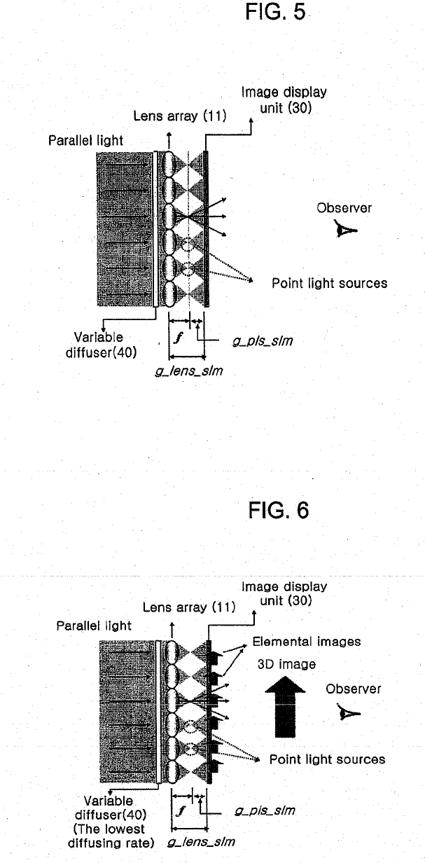

FIG. 5 shows a diagram of the convertible display device according to the first preferred embodiment of the present invention.

In the convertible display device according to the first preferred embodiment of the present invention, the transmission-type image display unit 30 receives an image signal from the image processing unit 20 and displays it. The transmission-type image display unit 30 is a common 2D display device, such as a spatial light modulator or an LCD with the backlight unit removed. This embodiment uses a spatial light modulator as a transmission-type display unit.

The array forming unit 10 includes a lens array 11. The distance between the lens array 11 and the transmission-type image display unit 30 may be any length that is longer than the focal length of the lens array but shorter than twice the focal length of the lens array. The variable diffuser 40 may be located at any position between the lens array 11 and the transmission-type image display unit 30 or right behind the lens array 11. Here, the transmission-type image display unit 30 is assumed to be g_lens_slm(f<g_lens_slm≦2f) distant from the lens array 11 with a focal length of f, and the variable diffuser 40 is assumed to be right behind the back of the lens array 11.

The convertible display of the first embodiment of the present invention has two action modes, a 3D mode and a 2D mode. Hereafter, the action of each mode will be explained.

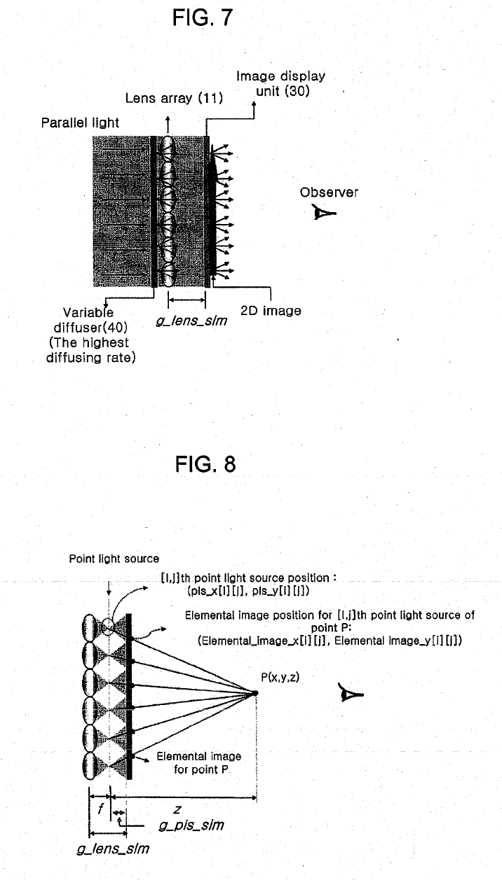

FIG. 6 and FIG. 7, respectively show the mechanism of a 3D mode and a 2D mode of the convertible display device according to the first preferred embodiment of the present invention.

First of all, FIG. 6 shows the action of the 3D mode. The diffusion rate is adjusted to the lowest value in the 3D mode. The diffusion rate may be controlled by applying a constant voltage to a PDLC (polymer-dispersed liquid crystal) when it is used as the variable diffuser 40, as in the first embodiment. The diffusion rate of the variable diffuser 40 in the 3D mode should be small enough that almost all of the incident parallel light passes through the variable diffuser 40 without being diffused or scattered significantly. When the variable diffusion rate is small enough, the incident parallel light passes through the variable diffuser 40 and is focused at the focal plane of the lens array 11. In this case, focuses of lenses of the lens array 11 are formed at the focal plane and then a point light source array DA composed of point light sources, the number of point light sources being the same as the number of lenses in the lens array 11, is formed at the focal plane of the lens array 11. The light emitted from the point light source array DA formed in this way builds a 3D image after passing through the transmission-type image display unit 30. At this time, elemental images are generated by the image processing unit 20 and are displayed on the transmission-type image display unit 30. The image processing unit 20 calculates elemental images from the 3D information of the 3D image and transmits the elemental images to the transmission-type image display unit 30. A specific explanation of the generation of the elemental images in the image processing unit 20 is given below.

If the transversal position of a point P on the 3D image is (x, y) in the Cartesian coordinate system, the depth (i.e., the distance between the plane of the point light source array and the position of the image) is z (z being positive when P is in front of the plane of the point light source array and negative when P is behind the plane of the point light source array), the coordinate of the center of the point light source that is i^{th} from the left and j^{th} from the top is (pls_x[i][j], pls_y[i][j]) (this coordinate is the same as the central coordinate of the elemental lens that is forming the point light source), the distance in the X direction between each point light source of the point light source array is Lx, the distance in the y direction between each point light source of the point light source array is Ly (Lx is the same as the distance in the X direction between the central coordinates of the elemental lenses and Ly is the same as the distance in the Y direction between the central coordinates of the elemental lenses), the focal length of the lens array is f, and the distance between the lens array and the transmission-type image display unit is g_lens_slm. Since the point light source array is generated on the focal plane of the lens array, the distance ‘g_pls_slm’ between the point light source array and the image display unit is calculated by the following equation.

g_{—}pls_{—}sim=g_lens_{—}slm_{—}−f (Equation2)

Here, the elemental image of the point P of the object for the point light source that is i^{th} from the left and j^{th} from the top becomes E_ij, and the position coordinate is expressed as in Equations 3 and 4.

Elemental_image_{—}x[i][j]=pls_{—}x[i][j]+((g_{—}pls_{—}slm)z)*(x−pls_{—}x[i][j]) (Equation 3)

Elemental_image_{—}y[i][j]=pls_{—}y[i][j]+((g_{—}pls_{—}slm)/z)*(y−pls_{—}y[i][j]) (Equation 4)

The equations above can be easily obtained using the proportional relation of the two similar triangles shown in the FIG. 8 which shows the concept of the elemental image generation. However, the point E_ij, which is obtained from Equations 3 and 4, cannot be the elemental image for the point light source that is i^{th} from the left and j^{th} from the top unless it satisfies the following two conditions.

−Lx/2<Elemental_image_{—}x[i][j]−pls_{—}x[i][j]<Lx/2 (Condition 1)

−Ly/2<Elemental_image_{—}y[i][j]−pls_{—}y[i][j]<Ly/2 (Condition 2)

If the calculated value of Equation 3 and Equation 4 does not satisfy both Condition 1 and Condition 2 simultaneously, then the E_ii point cannot be the elemental image of point P. Making the elemental image using all the calculated points of Equation 3 and Equation 4 without considering Condition 1 and Condition 2 critically decreases the quality of the displayed 3D image by mutual interference in the elemental images of the point light sources. In this way, we can generate the elemental image for point P and we can get all the elemental images by executing the above calculation for all points of the 3D object and overlapping the calculated elemental images for each point. In the overlapping of the elemental images of each point of the 3D image, we must overlap the elemental images by retrograde order of depth, i.e., the elemental image for a larger z being placed on the elemental image for a smaller z. By the above process, we can prevent the 3D image from becoming pseudoscopy, that is, the same as with conventional computer-generated integral imaging (CGII) or computer-generated integral photography (CGIP). Another remarkable point of the embodiment of the present invention is that we do not consider the position of the observer when calculating the elemental image. The above remarkable point means that the 3D mode of the convertible display device according to the embodiment of the present invention has distinction from the conventional multi-view 3D display method using a point light source array. Namely, the conventional multi-view 3D display method using a point light source array assumes positions of the observer and generates images to be displayed on the transmission-type image display unit so that the observer can observe a corresponding image at each position. Then, the observer feels the cubic sense by binocular perspective. However, in the 3D mode of the convertible display device according to the embodiment of the present invention, the light from the point light source array is transmitted to the transmission-type image display unit. Then the light is appropriately modulated by the elemental image and formed to a real 3D image in a space. Therefore the observer feels perspective continuously in a fixed viewing angle regardless of the position of the observer. Accordingly, the 3D mode of the convertible display device according to the embodiment of the present invention is not a general multi-view 3D display but a sort of integral imaging. The general multi-view 3D display method concluding the way using point light source array considers the position of the observer (i.e., the position and the number of viewing points) when calculating an image to be displayed at the transmission-type image display unit. However, the 3D mode of the convertible display device according to the embodiment of the present invention only considers the information of the 3D object not the position of the observer as mentioned above when generating the elemental images.

The elemental images generated by this method are displayed at the transmission-type image display unit 30 and the light from the point light source array DA generated by the lens array 11 is appropriately modulated according to the elemental images displayed at the transmission-type image display unit 30, thereof forming a 3D image.

In the conventional integral image method, a 3D image is displayed by forming the elemental image using the lens array, and then the depth, direction, and position (z) of 3D image to be optimized and displayed according to the distance between the lens array and the image display unit is induced by Equation 1. In that case, the 3D image having limited depth can be displayed at around the position (z). Moreover, when displaying a real 3D image (z>0), the distance between the lens array and the image display unit should be longer than the focal length of the lens array according to Equation 1, and when displaying a virtual 3D image (z<0), the distance between the lens array and the image display unit should be shorter than the focal length of the lens array. Therefore, the conventional integral image method can only display one of a real 3D image and a virtual 3D image. However, according to the 3D mode of the convertible display device of the embodiment of the present invention, a 3D image is displayed not by formed images of elemental images but modulating light from point light sources through elemental images. Therefore, regardless of the depth, direction, and position (z) of the 3D image, and moreover, regardless of whether it is a real image (z>0) or a virtual image (z<0), the distance between the lens array and the image display unit is fixed. However, the elemental images displayed on the transmission-type image display unit can be altered and therefore the 3D mode of the convertible display device can display a real 3D image and a virtual 3D image simultaneously without any mechanical movement. As a result, the 3D mode of the convertible display device according to the embodiment of the present invention has a merit of greatly increasing a depth sense of a 3D image when compared with conventional integrated image processing.

The operation of a 2D mode of the convertible display according to the present invention will now be described.

FIG. 7 shows the operation of a 2D mode of the convertible display device according to the first preferred embodiment of the present invention. The 2D mode displays a 2D image and a diffusion rate is adjusted to a larger value in the 2D mode.

The parallel light coming from the rear is diffused by a variable diffuser and transmitted through the lens array in a condition of being irregularly spread in a wide angel without a regular direction. In this case, the distance between the variable diffuser and the lens array 11 is too short so that the lens array 11 cannot form the light spread by the variable diffuser 40 but only transmit it to the transmission-type image display unit 30. Therefore the light spread without a regular direction illuminates the transmission-type image display unit 30 and the observer just looks at a 2D image displayed on the transmission-type image display unit 30. As mentioned above, the image processing unit 20 in the 2D mode just transmits the 2D image to the transmission-type image display unit 30 without any special image processing and the observer just looks at the 2D image. In the embodiment of the present invention, the structure of the spread light illuminating the image display unit is the same as a general 2D display using a transmission-type display panel (e.g., an LCD). Therefore the observer can look at a 2D image with perfect resolution and viewing angle on the transmission-type image display unit 30 of the convertible display according to the embodiment of the present invention used in the 2D mode.

As mentioned above, in the first embodiment of the present invention, a 3D image with improved depth sense and a 2D image with a high resolution can be displayed by generating a point light source array using a lens array and parallel light and electrically adjusting the diffusion rate of a variable diffuser.

Next, a second embodiment of the present invention will be described.

The second embodiment of the present provides a method of structuring a 3D/2D convertible display by using a point light source array generated using an optical fiber array instead of the lens array and parallel light.

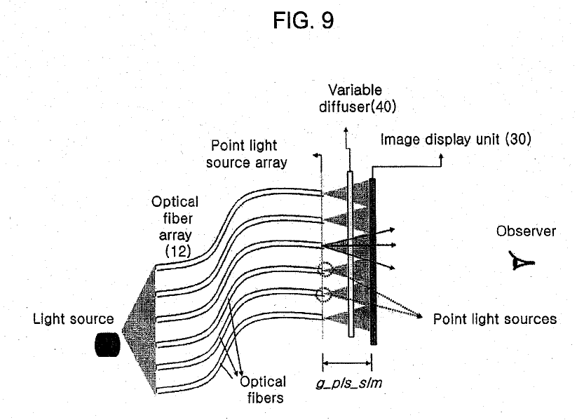

FIG. 9 shows the convertible display device according to the second embodiment of the present invention. As shown in FIG. 9, the structure of the convertible display device according to the second embodiment of the present invention is the same as that of the first embodiment except for the structure of the array forming unit 10.

In the convertible display device according to the second embodiment of the present invention the array forming unit 10 includes an optical fiber array 12 having at least one optical fiber transmitting light from one or more point light sources, instead of the lens array of the first embodiment. The variable diffuser 40 is located between the tip of the optical fiber array 12 and the transmission-type image display unit 30.

The light from the point light sources is transmitted to the transmission-type image display unit 30 through the optical fiber array 12. At this time, the light illuminated to the optical fiber array 12 from the point light sources moves according to the optical fibers of the optical fiber array 12 and spreads at the tips of the optical fibers. Therefore the tip of each optical fiber may be considered to be one point light source. The number of optical fibers and the distance between the optical fibers are respectively the same as the number of point light sources and the distance between the point light sources. Also, the distance between the tip of the optical fiber array 12 and the transmission-type image display unit 30 is the same as the distance ‘g_pls_slm’ in the first embodiment between the point light source array and the image display unit because the surface generated by the point light source array is the same as the surface formed at the tip of the optical fiber array.

Therefore the diffusion rate of the variable diffuser 40 may be lowest in the 3D mode of the convertible display device according to the second embodiment of present invention and the image processing unit 20 displays a 3D image by generating the elemental image as in the first embodiment using the Equations 3 and 4 and the Conditions 1 and 2 and then displaying the 3D image at the transmission-type image display unit 30. In the 2D mode, the light from the tip of the optical fiber array 12 is diffused with an increased diffusion rate by the variable diffuser 40 to illuminate the transmission-type image display unit 30 and so the convertible display device can display a 2D image on the surface of the transmission-type image display unit 30.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A convertible display device comprising:
an image processing unit that provides elemental images for display of a three-dimensional image or provides a two-dimensional image for display of a two-dimensional image;
a transmission-type image display unit that shows the elemental images or the two-dimensional image provided by the image processing unit;
an array forming unit that forms a point light source array comprised of a plurality of point light sources, the light from the point light sources being transmitted to the transmission-type image display unit; and
a variable diffuser that controls the diffusion rate of the light from the point light source array so that the image displayed by the transmission-type image display unit is displayed as a three-dimensional image or a two-dimensional image.

2. The convertible display device of claim 1, wherein: in displaying a three-dimensional image, the variable diffuser controls the diffusion rate to be lower than a predetermined value, the image processing unit provides the elemental images for the three-dimensional image, and the transmission-type image display unit displays the elemental images; and
in displaying a two-dimensional image, the variable diffuser controls the diffusion rate to be higher than the predetermined value, the image processing unit provides and transmits the two-dimensional image as it is to the image display unit, and the transmission-type image display unit displays the two-dimensional image.

3. The convertible display device of claim 1, further comprising a mode selecting unit that controls a diffusion rate of the variable diffuser according to a mode.

4. The convertible display device of claim 1, wherein the image processing unit generates an elemental image for point P by the following equations when the coordinates for point P of the 3D object image information are (x,y) and the distance from the point light source array to the position at which point P is formed is z,
Elemental_image_{—}x[i][j]=pls_{—}x[i][j]+((g_{—}pls_{—}slm)/z)*(x−pls_{—}x[i][j])
Elemental_image_{—}y[i][j]=pls_{—}y[i][j]+((g_{—}pls_{—}slm)/z)*(y−pls_{—}y[i][j])
wherein, pls_x[i][j] and pls_y[i][j]) are center coordinates of a point light source located i^{th} from the left and j^{th} from the top of the point light source array, and
g_pls_slm is the distance from the point light source array to the transmission-type image display unit.

5. The convertible display device of claim 4, wherein the image processing unit 3 samples the elemental images having a value satisfied following condition among the elemental images of point P calculated the above equation and sets the sampled elemental images as the elemental image of point P,
−Lx/2<Elemental_image_{—}x[i][j]−pls_{—}x[i][j]<Lx/2
−Ly/2<Elemental_image_{—}y[i][j]−pls_{—}y[i][j]<Ly/2
wherein, Lx is the distance in the x direction between each point light source of the point light source array, and
Ly is the distance in the y direction between each point light source of the point light source array.

6. The convertible display device of claim 1, wherein the array forming unit includes a lens array composed of a plurality of elemental lenses and the point light source array is formed at the focal plane of the lens array since parallel light is incident to the lens array.

7. The convertible display device of claim 6, wherein the transmission-type image display unit is located g_lens_slm(f<g_lens_slm≦2f) distant from the lens array, the focal length of which is f.

8. The convertible display device of claim 1, wherein the array forming unit includes an optical fiber array composed of at least one optical fiber transmitting light from one or more point light sources.

9. The convertible display device of claim 1, wherein the variable diffuser is a polymer-dispersed liquid crystal that varies the diffusion rate of the incident light according to a voltage applied.

10. The convertible display device of claim 2, wherein the array forming unit includes a lens array composed of a plurality of elemental lenses and the point light source array is formed at the focal plane of the lens array since parallel light is incident to the lens array.

11. The convertible display device of claim 3, wherein the array forming unit includes a lens array composed of a plurality of elemental lenses and the point light source array is formed at the focal plane of the lens array since parallel light is incident to the lens array.

12. The convertible display device of claim 4, wherein the array forming unit includes a lens array composed of a plurality of elemental lenses and the point light source array is formed at the focal plane of the lens array since parallel light is incident to the lens array.

13. The convertible display device of claim 5, wherein the array forming unit includes a lens array composed of a plurality of elemental lenses and the point light source array is formed at the focal plane of the lens array since parallel light is incident to the lens array.

14. The convertible display device of claim 2, wherein the array forming unit includes an optical fiber array composed of at least one optical fiber transmitting light from one or more point light sources.

15. The convertible display device of claim 3, wherein the array forming unit includes an optical fiber array composed of at least one optical fiber transmitting light from one or more point light sources.

16. The convertible display device of claim 4, wherein the array forming unit includes an optical fiber array composed of at least one optical fiber transmitting light from one or more point light sources.

17. The convertible display device of claim 5, wherein the array forming unit includes an optical fiber array composed of at least one optical fiber transmitting light from one or more point light sources.
